(19) United States
(12) Patent Application Publication
(10) Pub. No.: US 2026/0211997 A1
(43) Pub. Date: Jul. 23, 2026

(54) Secure Runtime Enforcement of Agentic Workflows based on Tool Invocation Intent

(71) Applicant: International Business Machines Corporation, Armonk, NY (US)

(72) Inventors: Julian James Stephen, Yorktown Heights, NY (US); Frederico Araujo, Mahopac, NY (US); Md Salman Ahmed, Danbury, CT (US); Michael Vu Le, Danbury, CT (US); Hani Talal Jamjoom, Cos Cob, CT (US); Arjun Natarajan, Old Tappan, NJ (US)

(21) Appl. No.: 19/034,949

(22) Filed: Jan. 23, 2025

(51) Int. Cl. G06F 21/50; G06F 8/30; G06Q 10/0631

(52) U.S. Cl. CPC G06F 21/50; G06F 8/30; G06Q 10/06316

(57) ABSTRACT

Managing agentic workflows is provided. A runtime execution environment customized for a tool invoked by an AI agent to perform a task corresponding to a user request is generated. The runtime execution environment customized for the tool enforces at least one of a set of tool execution security policies corresponding to the tool, tool permissions of the tool, user's intent, and a data flow analysis to prevent security threats. The tool invoked by the AI agent to perform the task corresponding to the user request is executed in the runtime execution environment customized for the tool. Execution of the tool is monitored in real time while performing the task corresponding to the user request in the runtime execution environment customized for the tool.

### BACKGROUND

The disclosure relates generally to agentic workflows and more specifically to managing agentic workflows.

Agentic workflows, or agentic processes, refer to an iterative and multi-step approach to using artificial intelligence (AI) agents to perform tasks, as opposed to traditional non-agent approaches of providing a prompt and receiving a single, direct response. AI agents leverage large language models (LLMs) to perform sophisticated, autonomous actions. AI agents can transcend traditional AI capabilities by not just generating responses but by actively engaging with a variety of tools. Examples of tools include, for example, web search engines, code execution environments, image manipulation software, and the like. This versatility of engaging with a variety of tools allows AI agents to perform a wide range of tasks, from conducting web searches and executing code to manipulating images, thereby extending the utility and capabilities of these AI agents.

AI agents divide tasks into manageable steps. For example, AI agents determine the sequence of steps needed to accomplish a task and adapt their plans when faced with challenges. In other words, AI agents have the ability to reason, problem solve, select a course of action, execute the selected course of action, and adapt to changing circumstances while executing the selected course of action without human intervention.

### SUMMARY

According to one illustrative embodiment, a computer-implemented method is provided. The computer-implemented method generates a runtime execution environment customized for a tool invoked by an AI agent to perform a task corresponding to a user request. The runtime execution environment customized for the tool enforces at least one of a set of tool execution security policies corresponding to the tool, tool permissions of the tool, and a data flow analysis to prevent security threats. The computer-implemented method executes the tool invoked by the AI agent to perform the task corresponding to the user request in the runtime execution environment customized for the tool. The computer-implemented method monitors execution of the tool in real time while performing the task corresponding to the user request in the runtime execution environment customized for the tool. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of an agentic workflow management system in accordance with an illustrative embodiment; and

FIGS. 3A-3C are a flowchart illustrating a process for managing agentic workflows based on tool invocation intent by AI agents in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

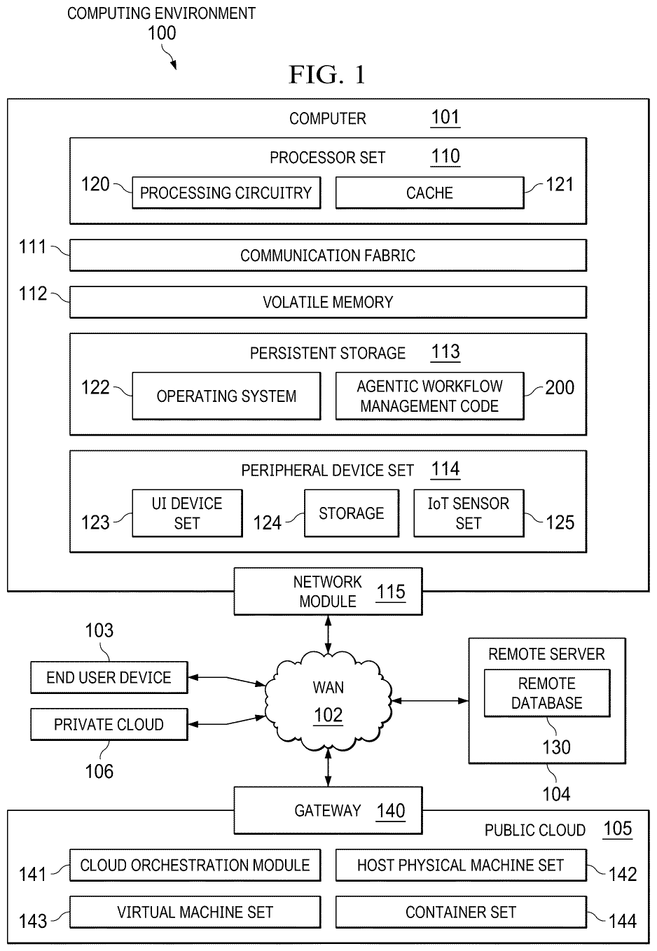

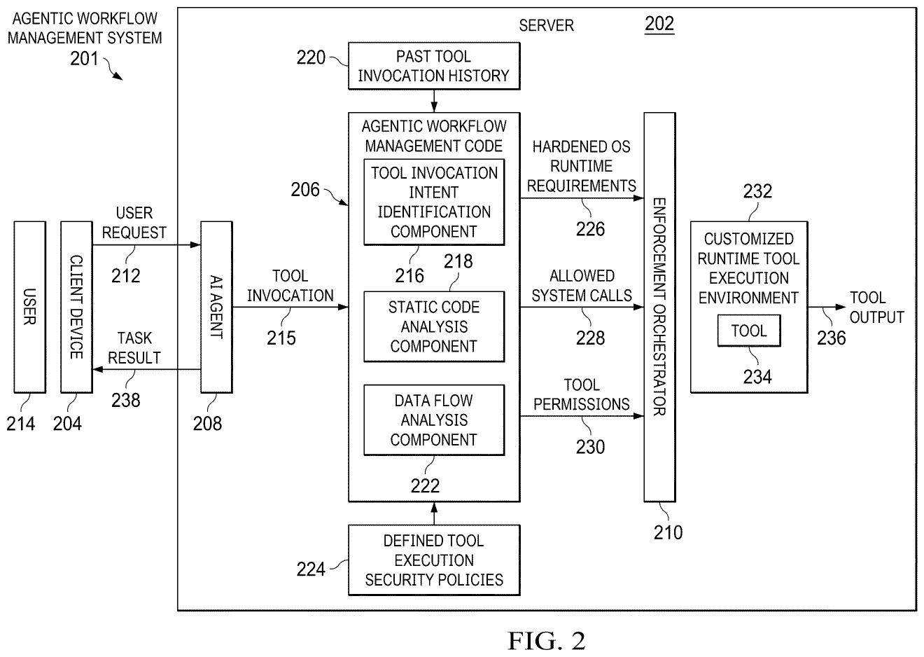

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as agentic workflow management code 200.

For example, agentic workflow management code 200 identifies intent of tool invocation by an AI agent. Depending on the tool invoked by the AI agent, illustrative embodiments analyze the AI agent tool invocation in conjunction with the description of the tool to identify intent of invoking that particular tool by the AI agent. The intent of invoking a particular tool by an AI agent is associated with the specific user request submitted to the AI agent by a user to perform a particular task (e.g., answer a question, generate content, solve a problem, perform a calculation, or the like). Agentic workflow management code 200 performs at least one of static code analysis, tool prompt analysis, data sensitivity analysis, or data flow analysis between different tools as needed, depending on the tool invoked by the AI agent. It should be noted that agentic workflow management code 200 does not need prior LLM training or training data.

Agentic workflow management code 200 also provides a customized runtime execution environment for an invoked tool by an AI agent. Agentic workflow management code 200 automatically generates a sandboxed or isolated customized runtime execution environment (e.g., confidential virtual machine, confidential container, or the like) to securely execute the tool invoked by the AI agent in response to the specific user request to perform the task by the AI agent. Agentic workflow management code 200 customizes the execution environment to the specific tool invoked by the AI agent based on defined tool execution security policies, tool permissions such as allowed system calls, and the like.

In addition, agentic workflow management code 200 records or logs any execution violations by the tool during performance of the task as AI agent feedback for AI agent self-reflection. AI agent self-reflection is a hallucination mitigation technique. For example, AI agent self-reflection reduces AI agent hallucinations by improving the factuality and consistency of AI-generated responses to user requests. In other words, AI agent self-reflection can detect and correct hallucinations in AI-generated content. An AI agent hallucination is when an AI agent fabricates content (e.g., generates inaccurate information) and presents the fabricated content as factual.

Agentic workflow management code 200 enables entities, such as, for example, enterprises, companies, businesses, organizations, institutions, agencies, developers, system administrators, and the like, to define customized tool execution security policies. In addition, agentic workflow management code 200 enables selection between different customized tool execution environments. Further, agentic workflow management code 200 maintains a history of past tool invocations and analyzes AI agent conversations to identify which customized tool execution environment to utilize to securely execute the tool invoked by the AI agent to prevent data or system compromise.

Illustrative embodiments preferably deploy agentic workflow management code 200 to AI agents as a library so the AI agents can sanitize tool invocations and provide customized sandboxed tool execution environments. As an alternative, illustrative embodiments deploy agentic workflow management code 200 to AI agents as a service so that AI agents can invoke tools to perform tasks associated with user requests in a secure manner. As yet another alternative, illustrative embodiments deploy agentic workflow management code 200 as a “sidecar container” or an additional container to the container executing the AI agent in a container-based environment so that agentic workflow management code 200 deployed in the sidecar container can transparently intercept communications of the AI agent to securely perform runtime tasks by the invoked tool.

In addition to agentic workflow management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and agentic workflow management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in agentic workflow management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a user of the agentic workflow management services provided by computer 101), and may take any of the forms discussed above in connection with computer 101. EUD 103 typically receives helpful and useful data from the operations of computer 101. For example, in a hypothetical case where computer 101 is designed to provide an AI agent task result to the end user, this AI agent task result would typically be communicated from network module 115 of computer 101 through WAN 102 to EUD 103. In this way, EUD 103 can display, or otherwise present, the AI agent task result to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide an AI agent task result based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

In agentic workflows, an AI agent determines which set of tools to invoke in response to a user request (e.g., user query or question). The AI agent generates invocations or prompts to a set of tools needed to respond to the user request to perform a task and determines the sequence for invoking the set of tools. The AI agent can also generate tools via code generation when a particular tool is needed to perform the task associated with the user request. However, malicious users can manipulate a hallucinating AI agent to invoke tools insecurely or to generate malicious tools, which can result in system intrusions, sensitive data leaks, compromised systems, and the like.

In one type of existing solutions, AI agents input tool invocations into an LLM and the LLM outputs sanitized tool invocations for the AI agents. In another type of existing solutions, the LLM is pre-tuned with safeguards that encode specific behavior for the AI agents. Some other existing solutions allow AI agents to use tools without safeguards.

The goal is to prevent AI agents from hallucinating, which can result in compromised data and systems. In other words, an issue with AI agents is AI agent hallucinations. An AI agent hallucination is when an AI agent fabricates information (e.g., generates inaccuracies) and presents the fabricated information as factual. Illustrative embodiments combine AI agent tool invocation intent analysis with customized runtime tool execution environment enforcement to prevent AI agent hallucinations from leaking sensitive data or compromising systems by sanitizing tool invocations and sandboxing tool executions.

AI agents are agentic workflows that, for example: 1) access memory, such as AI agent past tool invocation logs and conversation histories; 2) perform reasoning, such as generate a plan to perform a task and a reason for each step of the task; and 3) act to invoke one or more tools to perform the task, such as search, invoke a defined set of allowable service APIs, execute code, invoke a set of different AI agents or LLMs, perform calculations, and the like. However, these agentic workflows are prone to security issues. For example, hallucinating AI agent misdeeds can include, for example: an AI agent invoking a tool to delete sensitive data or share sensitive data with unauthorized users; an AI agent inadvertently creating one or more breaches in a system firewall; an AI agent generating code for a tool that is not secure to use; an AI agent generating extraneous code that invokes unnecessary tools; and the like. In addition, an AI agent can employ coding practices that are not secure by, for example, generating code with unsecure function calls, using outdated hashing algorithms, and the like.

Further, an AI agent can be subject to prompt injection attacks that can successfully exfiltrate system configurations, sensitive data, and the like. Prompt injection is a type of cyberattack against AI agents. For example, a malicious user can disguise malicious inputs as legitimate queries to manipulate an AI agent into leaking sensitive data, disseminating misinformation, compromising systems, and the like. Prompt injection takes advantage of an AI agent's ability to respond to a user's natural language instructions. By writing a carefully crafted query, a malicious user can override developer instructions to cause an AI agent to perform unauthorized or malicious tasks.

Illustrative embodiments identify the intent of a tool invocation by an AI agent. Illustrative embodiments perform static code analysis for code profile identification, insecure or extraneous code identification of tool permissions or privileges by scanning generated tool code using static code analysis techniques. For example, illustrative embodiments are capable of static, ahead-of-time compilation of interpreted code to native machine code that can be accurately analyzed (e.g., through static binary analysis of application binary interfaces). Illustrative embodiments analyze system calls and library API calls to identify the tool permissions (e.g., tool code privileges), operating system (OS) runtime requirements (e.g., removal of unnecessary OS features), and the like.

In addition, illustrative embodiments perform data flow analysis between a series of different tools based on past tool invocations by an AI agent. Illustrative embodiments utilize the data flow analysis between the different tools to detect hidden security threats that may not show up independently in one tool. For example, illustrative embodiments analyze the sequence of past tool invocations by the AI agent and correlate the tasks performed by the tools to detect any security threats. Illustrative embodiments perform the data flow analysis across REST APIs and tool invocations to detect, for example, AI agent hallucination side effects, excessive tool agency to perform more actions than configured for, and the like.

Further, illustrative embodiments perform natural language processing to identify AI agent tool invocation intent. Illustrative embodiments use, for example, N-version LLMs, action categorization, or the like for tool invocation intent classification. The tool invocation intent classification identifies which particular task an AI agent is requesting a particular tool to perform based on the specific user request.

Illustrative embodiments enforce a customized runtime execution environment for a tool invoked by an AI agent. Illustrative embodiments route tasks to be performed by tools to designated customized runtime execution environments based on, for example, defined execution security policies and tool permissions identified by the static code analysis. A customized runtime execution environment may be, for example, a confidential container or virtual machine, a sandbox with limited execution privileges that restricts system calls, a geolocation dependent customized runtime execution environment, a hardened OS runtime, and the like. For example, illustrative embodiments can generate a customized runtime execution environment configuration for executing a tool invoked by an AI agent by, for example, using an OS kernel security module that restricts tool privileges, system calls, and the like. In addition, illustrative embodiments can generate a customized runtime execution environment configuration for executing a tool invoked by an AI agent by removing one or more unnecessary features of the OS. Illustrative embodiments can harden a customized runtime execution environment via OS system feature reduction using host-based OS debloating, library-based application binary interface debloating that is similar to library operating systems, and the like.

Thus, illustrative embodiments provide one or more technical solutions that overcome a technical problem with an inability of existing solutions to securely execute a tool to perform a task associated with a user request in a customized runtime tool execution environment based on intent of tool invocation by an AI agent. As a result, these one or more technical solutions provide a technical effect and practical application in the field of agentic workflows.

With reference now to FIG. 2, a diagram illustrating an example of an agentic workflow management system is depicted in accordance with an illustrative embodiment. Agentic workflow management system 201 may be implemented in a computing environment, such as computing environment 100 in FIG. 1. Agentic workflow management system 201 is a system of hardware and software components for managing agentic workflows based on AI agent tool invocation intent corresponding to user requests to perform tasks by AI agents.

In this example, agentic workflow management system 201 includes server 202 and client device 204. Server 202 may be, for example, computer 101 in FIG. 1. Client device 204 may be, for example, EUD 103 in FIG. 1. However, it should be noted that agentic workflow management system 201 is intended as an example only and not as a limitation on illustrative embodiments. For example, agentic workflow management system 201 can include any number of servers, client devices, and other devices and components not shown.

In this example, server 202 includes agentic workflow management code 206, AI agent 208, and enforcement orchestrator 210. Agentic workflow management code 206 may be, for example, agentic workflow management code 200 in FIG. 1. AI agent 208 may represent any type of AI agent, such as, for example, an LLM or the like, that is responsive to any type of user request for performance of a task. In addition, even though AI agent 208 is located in server 202 in this example, in an alternative illustrative embodiment AI agent 208 may be located in a separate server or other type of data processing system. Agentic workflow management code 206 utilizes enforcement orchestrator 210 to enforce defined tool execution security policies when a customized runtime tool execution environment is running a tool to perform a task associated with a user request to decrease or eliminate data or system compromise, thereby increasing data and system security.

At 212, user 214 uses client device 204 to send a user request to perform a task to AI agent 208. AI agent 208 determines that a tool is needed to perform the task corresponding to the user request. As a result, at 215, AI agent 208 sends a tool invocation to agentic workflow management code 206 for invoking the tool needed to perform the task.

In response to receiving the tool invocation from AI agent 208, agentic workflow management code 206 utilizes tool invocation intent identification component 216 to identify the purpose or reason for AI agent 208 invoking the tool to perform the task associated with the user request. Agentic workflow management code 206 may retrieve a description of the tool to assist in determining what AI agent 208 wants to use the tool for.

In addition, in response to determining that code needs to be generated for the tool based on the identified tool invocation intent, agentic workflow management code 206 generates the code for the tool. In addition, agentic workflow management code 206 utilizes static code analysis component 218 to analyze the code generated for the tool to identify tool permissions or privileges of the tool while performing the task associated with the user request.

Further, based on analyzing past tool invocation history 220, agentic workflow management code 206 utilizes data flow analysis component 222 to perform a data flow analysis between tools previously invoked by AI agent 208 to identify any security threats posed by the tool while interacting with other tools to perform the task associated with the user request. Furthermore, agentic workflow management code 206 retrieves defined tool execution security policies 224 corresponding to the tool to identify, for example, hardened OS runtime requirements, allowed system calls, and the like.

At 226, agentic workflow management code 206 inputs the hardened OS runtime requirements into enforcement orchestrator 210. At 228, agentic workflow management code 206 also inputs the allowed system calls into enforcement orchestrator 210. In addition, at 230, agentic workflow management code 206 inputs the tool permissions into enforcement orchestrator 210.

Agentic workflow management code 206 utilizes enforcement orchestrator 210 to generate customized runtime tool execution environment 232, which is specifically tailored to tool 234 based on the information (e.g., the hardened OS runtime requirements, allowed system calls, tool permissions, defined tool execution security policies, and the like corresponding to tool 234) input into enforcement orchestrator 210. Agentic workflow management code 206 utilizes customized runtime tool execution environment 232 to run tool 234 to securely perform the task associated with the user request by preventing data or system compromise during performance of the task.

At 236, upon completion of the task associated with the user request, tool 234 generates the tool output, which is the result of the task performed by tool 234. Agentic workflow management code 206 sends the result of the task to AI agent 208. At 238, AI agent 208 sends the task result to client device 204 for user 214 to review.

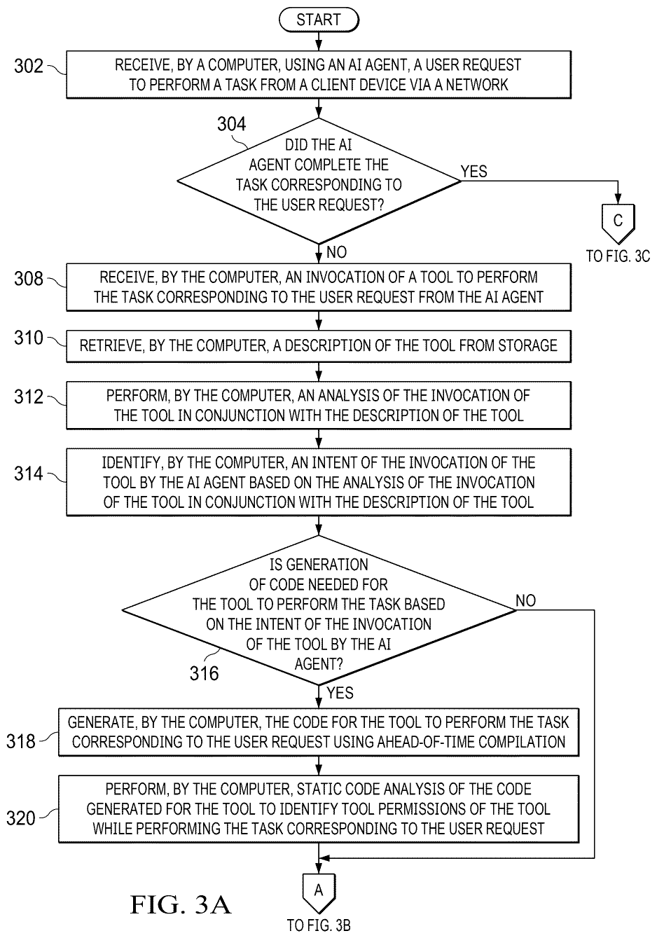

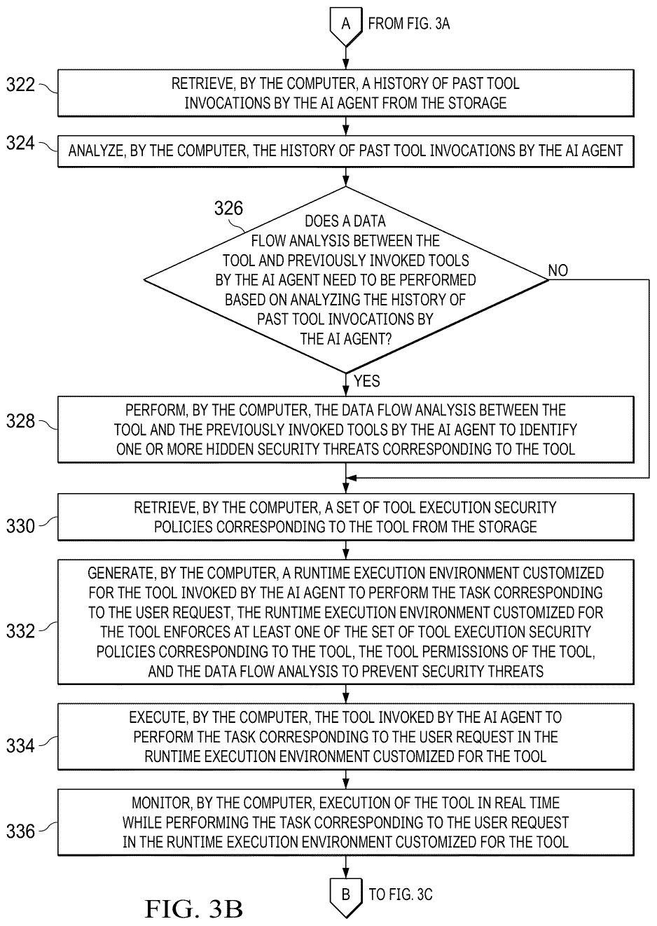

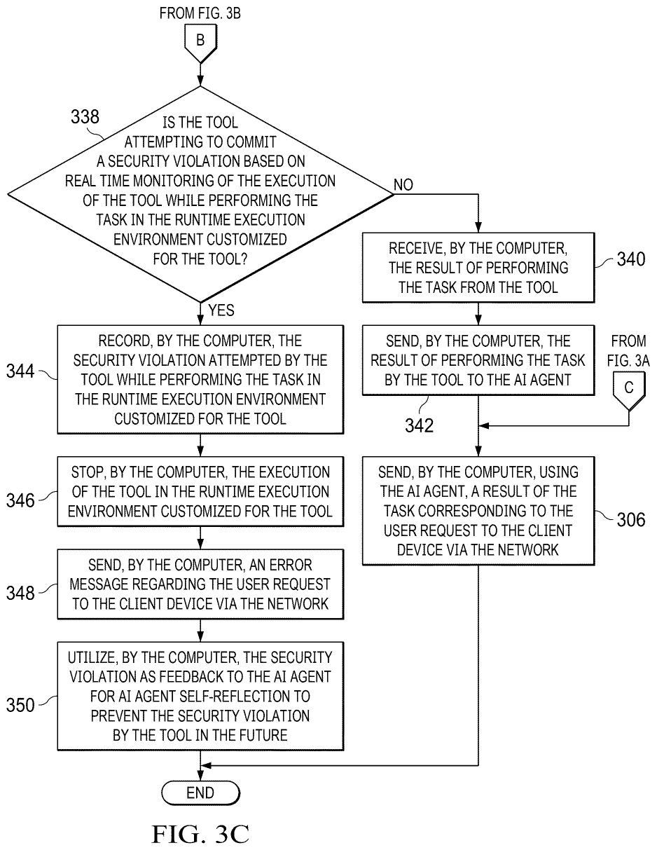

With reference now to FIGS. 3A-3C, a flowchart illustrating a process for managing agentic workflows based on tool invocation intent by AI agents is shown in accordance with an illustrative embodiment. The process shown in FIGS. 3A-3C may be implemented in a computer, such as, for example, computer 101 in FIG. 1 or server 202 in FIG. 2. For example, the process shown in FIGS. 3A-3C may be implemented by agentic workflow management code 200 in FIG. 1 or agentic workflow management code 206 in FIG. 2.

The process begins when the computer, using an AI agent, receives a user request to perform a task from a client device via a network (step 302). The computer makes a determination as to whether the AI agent completed the task corresponding to the user request (step 304). If the computer determines that the AI agent did complete the task corresponding to the user request, yes output of step 304, then the computer, using the AI agent, sends a result of the task corresponding to the user request to the client device via the network (step 306). Thereafter, the process terminates.

If the computer determines that the AI agent did not complete the task corresponding to the user request, no output of step 304, then the computer receives an invocation of a tool to perform the task corresponding to the user request from the AI agent (step 308). In response to receiving the invocation of the tool to perform the task, the computer retrieves a description of the tool from storage (step 310). The computer performs an analysis of the invocation of the tool in conjunction with the description of the tool (step 312). The computer may utilize, for example, natural language processing, natural language understanding, and the like to analyze the tool invocation and description.

The computer identifies an intent of the invocation of the tool by the AI agent based on the analysis of the invocation of the tool in conjunction with the description of the tool (step 314). The computer makes a determination as to whether generation of code is needed for the tool to perform the task based on the intent of the invocation of the tool by the AI agent (step 316). If the computer determines that generation of code is not needed for the tool to perform the task based on the intent of the invocation of the tool by the AI agent, no output of step 316, then the process proceeds to step 322.

If the computer determines that generation of code is needed for the tool to perform the task based on the intent of the invocation of the tool by the AI agent, yes output of step 316, then the computer generates the code for the tool to perform the task corresponding to the user request using ahead-of-time compilation (step 318). In addition, the computer performs static code analysis of the code generated for the tool to identify tool permissions, insecure or extraneous code of the tool while performing the task corresponding to the user request (step 320).

Further, the computer retrieves a history of past tool invocations by the AI agent from the storage (step 322). The computer analyzes the history of past tool invocations by the AI agent (step 324). The computer makes a determination as to whether a data flow analysis between the tool and previously invoked tools by the AI agent is needed to be performed based on analyzing the history of past tool invocations by the AI agent (step 326). If the computer determines that a data flow analysis between the tool and previously invoked tools by the AI agent does need to be performed based on analyzing the history of past tool invocations by the AI agent, yes output of step 326, then the computer performs the data flow analysis between the tool and the previously invoked tools by the AI agent to identify one or more hidden security threats corresponding to the tool (step 328). Thereafter, the process proceeds to step 330.

If the computer determines that a data flow analysis between the tool and previously invoked tools by the AI agent does not need to be performed based on analyzing the history of past tool invocations by the AI agent, no output of step 326, then the computer retrieves a set of tool execution security policies corresponding to the tool from the storage (step 330). The set of tool execution security policies restrict certain actions taken by the tool while performing the task to increase data security and computer security.

The computer generates a runtime execution environment customized for the tool invoked by the AI agent to perform the task corresponding to the user request (step 332). The runtime execution environment customized for the tool enforces at least one of the set of tool execution security policies corresponding to the tool, the tool permissions of the tool, and the data flow analysis to prevent security threats. The computer executes the tool invoked by the AI agent to perform the task corresponding to the user request in the runtime execution environment customized for the tool (step 334). Further, the computer monitors execution of the tool in real time while performing the task corresponding to the user request in the runtime execution environment customized for the tool (step 336).

The computer makes a determination as to whether the tool is attempting to commit a security violation based on real time monitoring of the execution of the tool while performing the task in the runtime execution environment customized for the tool (step 338). If the computer makes determines that the tool is not attempting to commit a security violation based on the real time monitoring of the execution of the tool while performing the task in the runtime execution environment customized for the tool, no output of step 338, then the computer receives the result of performing the task from the tool (step 340). The computer sends the result of performing the task by the tool to the AI agent (step 342). Thereafter, the process returns to step 306 where the computer, using the AI agent, sends the result of the task corresponding to the user request to the client device.

If the computer makes determines that the tool is attempting to commit a security violation based on the real time monitoring of the execution of the tool while performing the task in the runtime execution environment customized for the tool, yes output of step 338, then the computer records the security violation attempted by the tool while performing the task in the runtime execution environment customized for the tool (step 344). Furthermore, the computer stops the execution of the tool in the runtime execution environment customized for the tool (step 346). Moreover, the computer sends an error message regarding the user request to the client device via the network (step 348). In addition, the computer utilizes the security violation as feedback to the AI agent for AI agent self-reflection to prevent the security violation by the tool in the future (step 350). Thereafter, the process terminates.

Thus, illustrative embodiments of the present disclosure provide a computer-implemented method, computer system, and computer program product for managing agentic workflows for increased data and system security by preventing data or system compromise caused by AI agent hallucinations. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating a runtime execution environment customized for a tool invoked by an artificial intelligence (AI) agent to perform a task corresponding to a user request, the runtime execution environment customized for the tool enforces at least one of a set of tool execution security policies corresponding to the tool, tool permissions of the tool, and a data flow analysis to prevent security threats;
executing the tool invoked by the AI agent to perform the task corresponding to the user request in the runtime execution environment customized for the tool; and
monitoring execution of the tool in real time while performing the task corresponding to the user request in the runtime execution environment customized for the tool.

2. The computer-implemented method of claim 1, further comprising:
determining whether the tool is attempting to commit a security violation based on monitoring the execution of the tool in real time while performing the task in the runtime execution environment customized for the tool;
responsive to determining that the tool is attempting to commit the security violation based on monitoring the execution of the tool in real time while performing the task in the runtime execution environment customized for the tool, recording the security violation attempted by the tool while performing the task in the runtime execution environment customized for the tool; and
utilizing the security violation as feedback to the AI agent for AI agent self-reflection to prevent the security violation by the tool.

3. The computer-implemented method of claim 2, further comprising:
responsive to determining that the tool is not attempting to commit the security violation based on monitoring the execution of the tool in real time while performing the task in the runtime execution environment customized for the tool, receiving a result of performing the task from the tool;
sending the result of performing the task by the tool to the AI agent; and
sending, using the AI agent, the result of the task corresponding to the user request to a client device.

4. The computer-implemented method of claim 1, further comprising:
receiving, using the AI agent, the user request to perform the task from a client device via a network; and
determining whether the AI agent completed the task corresponding to the user request.

5. The computer-implemented method of claim 4, further comprising:
responsive to determining that the AI agent did not complete the task corresponding to the user request, receiving an invocation of the tool to perform the task corresponding to the user request from the AI agent;
retrieving a description of the tool in response to receiving the invocation of the tool to perform the task;
performing an analysis of the invocation of the tool in conjunction with the description of the tool; and
identifying an intent of the invocation of the tool by the AI agent based on the analysis of the invocation of the tool in conjunction with the description of the tool.

6. The computer-implemented method of claim 5, further comprising:
determining whether generation of code is needed for the tool to perform the task based on the intent of the invocation of the tool by the AI agent;
responsive to determining that generation of code is needed for the tool to perform the task based on the intent of the invocation of the tool by the AI agent, generating the code for the tool to perform the task corresponding to the user request; and
performing static code analysis of the code generated for the tool to identify the tool permissions of the tool while performing the task corresponding to the user request.

7. The computer-implemented method of claim 6, further comprising:
retrieving a history of past tool invocations by the AI agent;
analyzing the history of past tool invocations by the AI agent;
determining whether a data flow analysis between the tool and previously invoked tools by the AI agent is needed to be performed based on analyzing the history of past tool invocations by the AI agent; and
responsive to determining that the data flow analysis between the tool and previously invoked tools by the AI agent does need to be performed based on analyzing the history of past tool invocations by the AI agent, performing the data flow analysis between the tool and the previously invoked tools by the AI agent to identify one or more security threats corresponding to the tool.

8. The computer-implemented method of claim 7, further comprising:
responsive to determining that the data flow analysis between the tool and previously invoked tools by the AI agent does not need to be performed based on analyzing the history of past tool invocations by the AI agent, retrieving the set of tool execution security policies corresponding to the tool.

9. A computer system comprising:
a processor set;
one or more computer-readable storage media; and
program instructions stored on the one or more computer-readable storage media to cause the processor set to perform operations comprising:
generating a runtime execution environment customized for a tool invoked by an artificial intelligence (AI) agent to perform a task corresponding to a user request, the runtime execution environment customized for the tool enforces at least one of a set of tool execution security policies corresponding to the tool, tool permissions of the tool, and a data flow analysis to prevent security threats;
executing the tool invoked by the AI agent to perform the task corresponding to the user request in the runtime execution environment customized for the tool; and
monitoring execution of the tool in real time while performing the task corresponding to the user request in the runtime execution environment customized for the tool.

10. The computer system of claim 9, wherein the operations further comprise:
determining whether the tool is attempting to commit a security violation based on monitoring the execution of the tool in real time while performing the task in the runtime execution environment customized for the tool;
responsive to determining that the tool is attempting to commit the security violation based on monitoring the execution of the tool in real time while performing the task in the runtime execution environment customized for the tool, recording the security violation attempted by the tool while performing the task in the runtime execution environment customized for the tool; and
utilizing the security violation as feedback to the AI agent for AI agent self-reflection to prevent the security violation by the tool.

11. The computer system of claim 10, wherein the operations further comprise:
responsive to determining that the tool is not attempting to commit the security violation based on monitoring the execution of the tool in real time while performing the task in the runtime execution environment customized for the tool, receiving a result of performing the task from the tool;
sending the result of performing the task by the tool to the AI agent; and
sending, using the AI agent, the result of the task corresponding to the user request to a client device.

12. The computer system of claim 9, wherein the operations further comprise:
receiving, using the AI agent, the user request to perform the task from a client device via a network; and
determining whether the AI agent completed the task corresponding to the user request.

13. The computer system of claim 12, wherein the operations further comprise:
responsive to determining that the AI agent did not complete the task corresponding to the user request, receiving an invocation of the tool to perform the task corresponding to the user request from the AI agent;
retrieving a description of the tool in response to receiving the invocation of the tool to perform the task;
performing an analysis of the invocation of the tool in conjunction with the description of the tool; and
identifying an intent of the invocation of the tool by the AI agent based on the analysis of the invocation of the tool in conjunction with the description of the tool.

14. A computer program product comprising:
one or more computer-readable storage media; and
program instructions stored on the one or more computer-readable storage media to perform operations comprising:
generating a runtime execution environment customized for a tool invoked by an artificial intelligence (AI) agent to perform a task corresponding to a user request, the runtime execution environment customized for the tool enforces at least one of a set of tool execution security policies corresponding to the tool, tool permissions of the tool, and a data flow analysis to prevent security threats;
executing the tool invoked by the AI agent to perform the task corresponding to the user request in the runtime execution environment customized for the tool; and
monitoring execution of the tool in real time while performing the task corresponding to the user request in the runtime execution environment customized for the tool.

15. The computer program product of claim 14, wherein the operations further comprise:
determining whether the tool is attempting to commit a security violation based on monitoring the execution of the tool in real time while performing the task in the runtime execution environment customized for the tool;
responsive to determining that the tool is attempting to commit the security violation based on monitoring the execution of the tool in real time while performing the task in the runtime execution environment customized for the tool, recording the security violation attempted by the tool while performing the task in the runtime execution environment customized for the tool; and
utilizing the security violation as feedback to the AI agent for AI agent self-reflection to prevent the security violation by the tool.

16. The computer program product of claim 15, wherein the operations further comprise:
responsive to determining that the tool is not attempting to commit the security violation based on monitoring the execution of the tool in real time while performing the task in the runtime execution environment customized for the tool, receiving a result of performing the task from the tool;
sending the result of performing the task by the tool to the AI agent; and
sending, using the AI agent, the result of the task corresponding to the user request to a client device.

17. The computer program product of claim 14, wherein the operations further comprise:
receiving, using the AI agent, the user request to perform the task from a client device via a network; and
determining whether the AI agent completed the task corresponding to the user request.

18. The computer program product of claim 17, wherein the operations further comprise:
responsive to determining that the AI agent did not complete the task corresponding to the user request, receiving an invocation of the tool to perform the task corresponding to the user request from the AI agent;
retrieving a description of the tool in response to receiving the invocation of the tool to perform the task;
performing an analysis of the invocation of the tool in conjunction with the description of the tool; and
identifying an intent of the invocation of the tool by the AI agent based on the analysis of the invocation of the tool in conjunction with the description of the tool.

19. The computer program product of claim 18, wherein the operations further comprise:
determining whether generation of code is needed for the tool to perform the task based on the intent of the invocation of the tool by the AI agent;
responsive to determining that generation of code is needed for the tool to perform the task based on the intent of the invocation of the tool by the AI agent, generating the code for the tool to perform the task corresponding to the user request; and
performing static code analysis of the code generated for the tool to identify the tool permissions of the tool while performing the task corresponding to the user request.

20. The computer program product of claim 19, wherein the operations further comprise:
retrieving a history of past tool invocations by the AI agent;
analyzing the history of past tool invocations by the AI agent;
determining whether a data flow analysis between the tool and previously invoked tools by the AI agent is needed to be performed based on analyzing the history of past tool invocations by the AI agent; and
responsive to determining that the data flow analysis between the tool and previously invoked tools by the AI agent does need to be performed based on analyzing the history of past tool invocations by the AI agent, performing the data flow analysis between the tool and the previously invoked tools by the AI agent to identify one or more security threats corresponding to the tool.
